(19) United States
(12) Patent Application Publication
(10) Pub. No.: US 2013/0014413 A1
(43) Pub. Date: Jan. 17, 2013

(54) BUOYANT FIXED ENVELOPES ADVERTISING DEVICE HEATED BY SOLAR AND/OR ELECTRICAL POWER

(71) Applicant: Pablo Emilio Luzuriaga, Hallandale, FL (US)

(72) Inventor: Pablo Emilio Luzuriaga, Hallandale, FL (US)

(21) Appl. No.: 13/530,092

(22) Filed: Jun. 21, 2012

Related U.S. Application Data
(60) Provisional application No. 61/571,266, filed on Jun. 24, 2011.
(60) Provisional application No. 61/627,003, filed on Sep. 16, 2011.

(51) Int. Cl. G09F 15/00

(52) U.S. Cl. 40/538; 40/610

(57) ABSTRACT

Advertising envelopes are anchored light envelopes that display an advertising (32). They are filled with a gas. They are made with a light plastic film or paper. Said advertising envelope and gas together are heavier than the air. When said gas is heated, whether indistinctly during the day by the sun or at night by an electrical source the envelope gets lighter than the air. The fixed envelope raises and displays said message. Other optional elements used to set the advertising envelope on place that not necessarily all embodiments have are: an electricity generator (41), an electricity reservoir (54), a conductive element (51), a resistance (43), a lamp (43), a funnel (23) acting as a valve, a vehicle (27) that drags the envelope (32), a bridle (21), control lines (24), a fan (40), and a photoreceptor (42) connected to an electrical switch (57).

### CROSS-REFERENCE TO RELATED APPLICATIONS

This applications claims the benefits of provisional patent application Ser. No. 61/571,266, filed 2011 Jun. 24 by the present inventor and Ser. No. 61/627,003, filed 2011 Sep. 16 by the present inventor.

### BACKGROUND-PRIOR ART

The following is a tabulation of some prior art that presently appears relevant:

U.S. Patents

| Patent Number | Issue Date | Patentee |
|---|---|---|
| 6,874,263 | 2005 Apr. 05 | Masao Ohmuku |
| 6,804,905 | 2004 Oct. 19 | Frank Leo Burger III, Okey F Cobb Jr. |
| 6,238,259 | 2001 May 29 | Vincent Medina |
| 5,710,543 | 1998 Jan. 20 | George David Moore |
| 5,365,685 | 1994 Nov. 22 | Lynn D. Shank |
| 5,024,012 | 1991 Jun. 18 | Craig J. Lovik |
| 1,924,236 | 1933 Oct. 29 | Mayo Friedberg |
| 1,817,269 | 1931 Oct. 4 | J Roland Rohlfs |
| 1,642,022 | 1927 Sep. 13 | Jacon B. Groh |
| 64999695 | 2002 Dec. 31 | Robert O. Talamo |
| 6,422,506 | 2002 Jul. 23 | Christopher J. Colby |
| 4,581,897 | 1981 Apr. 21 | Fredrick Eshoo |
| 3,565,368 | 1971 | Woodcroft |
| 3,337,162 | 1967 Oct. 22 | Howard M. Bauserman |
| 3,220,671 | 1965 Nov. 30 | Leland E. Ashman |

### Nonpatent Literature Documents—Webpages

http://www.xump.com/science/UFOSolarBalloon.cfm?SID=12&gclid=CNjOyuX46a8
CFSFe7AodzkqxUw
http://compare.ebay.com/like/120897145864?var=Iv&Ityp=AllFixedPriceItemTypes&
var=sbar
http://www.stuff4crafts.com/mad-science-solar-balloon-kit-
800971.html?CAWELAID=693754239&gclid=CI-H2d_56a8CFQKCnQodXXfF1w
http://www.solar-balloons.com/
http://ballonsolaire.pagesperso-orange.fr/en-index.htm
http://www.youtube.com/watch?v=6sQ1B0aCSUc
http://www.rcgroups.com/forums/showthread.php?t=796020
http://www.forgottenfutures.co.uk/vickers/vick_06.gif
http://www.flickr.com/photos/vaguelyartistic/1386524468/
http://www.warrenater.co.uk/helikites_pigeon_scarer_15.html

Nowadays there are too many signs in the streets. People don't pay attention to them. Moreover those signs have the disadvantage of the city's high fees. In order to be successful in advertising, new ways to call people's attention are needed.

A lot of companies advertise products using balloons heavier than the air. They achieved their purposed of being seen by the nearby public. Some companies use colorful latex balloons with their logos printed to call the attention of people passing by. In less than a day the balloon's latex walls let the air escape losing the pressure and making the balloon shrink. Other companies build bigger balloons with the product's shape that they want to advertise. The balloons are attached to a fixed element as a cart, roof, etc. The air's pressure gives them the proper shape. The balloons get the attention of people passing by but they are also expensive.

Few companies go further and create larger balloons like zeppelins filled with Helium over flying cities and achieving the purpose of having more public seeing them. They are guided by people who fly with them. They are able to guide the zeppelin wherever they want to go. The disadvantages, however, are that Helium is extremely expensive and that they require a special material or fabric that doesn't allow Helium to escape. Moreover they need to be guided by people. All the above makes it harder for companies to advertise using zeppelins.

Solar balloons are the ones that are warmed by the sun. There are two kinds of solar balloons: The first kind is huge solar balloons used for people transportation. They are made in two different ways: with a transparent cover and a black color core or entirely black. Their shape and function are similar to the hot balloons. The other kind of solar balloons are the ones used for entertainment. In the market there are some solar black balloons that have cylindrical shapes. Most of them are homemade with a very thin plastic film; usually the solar balloons are made uniting garbage bags. The bags are opened and the edges are glued with masking tape. At the bottom they have a hole. The balloon's shape is controlled by the winds intensity. They are relatively easy to make and the main concern is that the balloon flies. They are created with simple and light shapes such as tetrahedron solar balloons, tubes solar balloons, regular hot air balloon shape. FIG. 1. They are released to fly free. Some of them have a line to control them.

If in the middle of the ocean or in the forest we find a floating balloon fastened with a line, there is an implicit message meaning that someone is in danger in the balloon's line end. But if the same balloon is seen in a popular beach, it only means that someone is having a good time riding a solar balloon. So, the balloon does not have any implied message by itself.

Hot balloons are the ones heated by gas combustion. The air gets so hot that lifts the heavy balloon, the gas tank and the passengers. The driver controls only the balloon's flight altitude. They are used as a mean of transportation and entertainment. They are scarcely used to advertise something, however the balloon direction is at the winds mercy. And if the goal is to advertise a product in a certain area, the balloon exposure in that area is only temporal. Also the trip is risky for the crew. All these causes do not make it a popular advertising tool.

### SUMMARY

In accordance with one embodiment of buoyant fixed envelopes advertising device heated by solar and/or electrical power consists in a fixed envelope filled with a gas that displays a message. The envelope 32 and the gas are heavier than the air, and when heated by the sun and/ or electrical power said advertising envelope becomes lighter than the air rising up and displaying the message. Said envelope has accessories components that can be present or absent in the advertising device and they are one or more photoreceptors 42, fans 40, fins 52, portable electricity generators 41, battery 54, platforms 53, metallic rings 36, banner posts 44, reflectors 39, vehicles 27, bridles 21, control lines 24, funnels 23, harness 26, mirrored plastic films, no insulated wires 50, insulated wires 51.

### ADVANTAGES

Several advantages of one or more aspects are as follows:

It is a cheap, eye catchy novelty way to advertise with envelopes that can be manufactured and used day and night.

Other advantages of one or more aspects will be apparent from a consideration of the drawings and ensuing description.

### DRAWINGS-FIGURES

In the drawings, closely related figures have the same numbers but different alphabetic suffixes. For clarification purposes the black plastic balloon has been drawn in white color and the light color logo letter has been drawn in black.

FIGS. 1.A to 1.D. show various aspects of a big advertising envelope promoting a soda bottle at night. The internal lights show the logo letters, going through the light colors of the letters of the logo.

FIG. 1A shows a sectional view.

FIG. 1B shows a perspective view.

FIG. 1C shows the lower end of the envelope embracing the anchoring metallic ring.

FIG. 1D shows the adjustable hook fixing the anchoring metallic ring.

FIG. 2 shows a similar device with a different envelope shape and design in accordance with other embodiment. It shows a perspective view of a cylindrical advertising envelope fixed to the same platform.

FIG. 3 shows a similar device in accordance with other embodiment, wherein the envelope is fixed to a building perimeter.

FIG. 4 shows a small advertising envelope promoting a soda in a bottle.

FIGS. 5A to 5B shows a big advertising envelope promoting a soda in a bottle anchored to a moving object and carrying a passenger.

FIG. 5A shows a perspective from the ground the advertising envelope.

FIG. 5B shows a detailed larger scale of the harness area.

FIG. 6 shows a perspective view from above of a big advertising envelope promoting a soda in a can.

FIG. 7 shows a perspective view from the ground of a tetrahedron advertising envelope promoting a soda.

FIG. 8 shows a perspective view from the ground of a cylindrical advertising envelope promoting a soda.

FIG. 9 shows a frontal view of an advertising envelope with letter shape advertising a soda.

FIG. 10A to 10B shows a view of an advertising envelope with bridles anchored as a kite with two faces and the inferior face advertising a logo.

FIG. 10A shows a hexagonal envelope from above.

FIG. 10B shows a sectional view from the hexagonal envelope.

FIG. 11 shows a perspective view of a flat advertising envelope with short lines advertising a logo and producing a shadow underneath for people to cover.

FIG. 12 shows a frontal view of an advertising envelope with the shape of a soccer goal.

### DRAWING-REFERENCE NUMERALS

20 insertion line
21 bridle
22 underneath hole
23 funnel
24 control line
25 anchor point
26 harness
27 vehicle
28 advertising
29 lateral base hole
30 joint bridle ring
31 insertion point
32 advertising envelope
33 label
34 cap
35 logo
36 anchoring metallic ring
37 lower end's edge
38 adjustable hooks
39 reflector
40 fan
41 electricity generator
42 photoreceptor
43 lamp
44 post banner
45 triangular extension and hole
46 central insertion line
47 central metallic ring
48 lower circle
49 upper circle
49 upper circle bis
51 insulated wire
52 fin
53 platform
54 battery
55 wind interaction hole

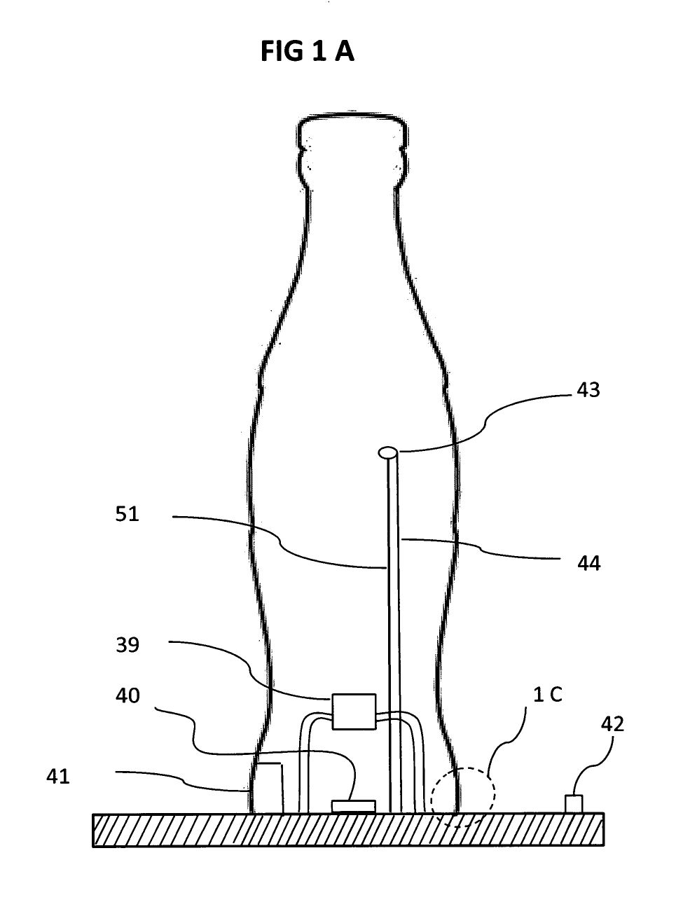

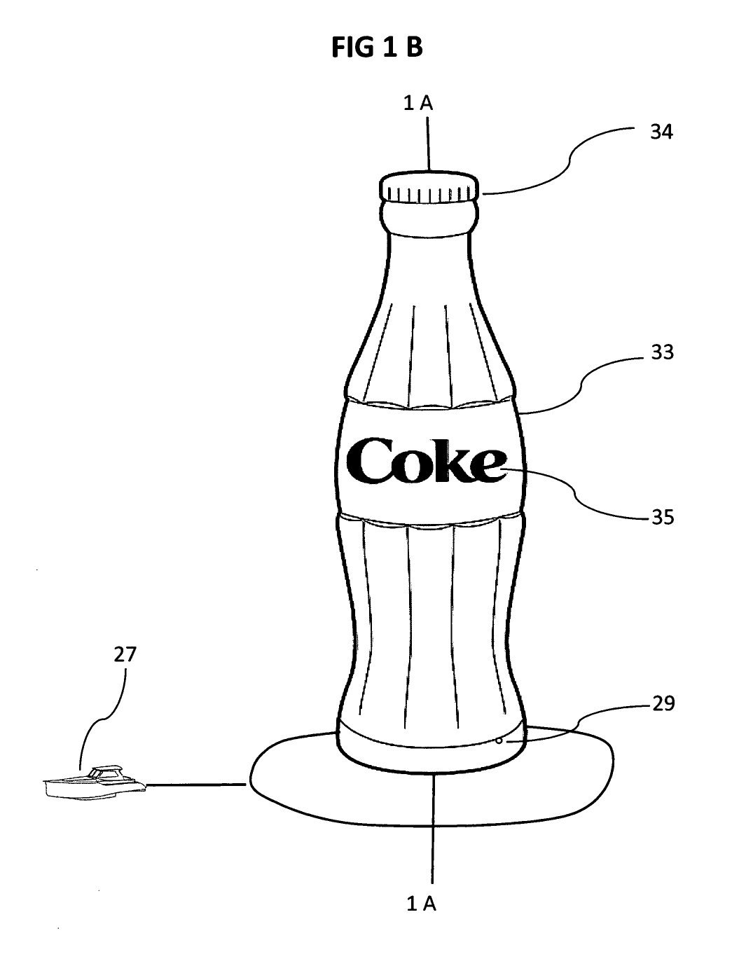

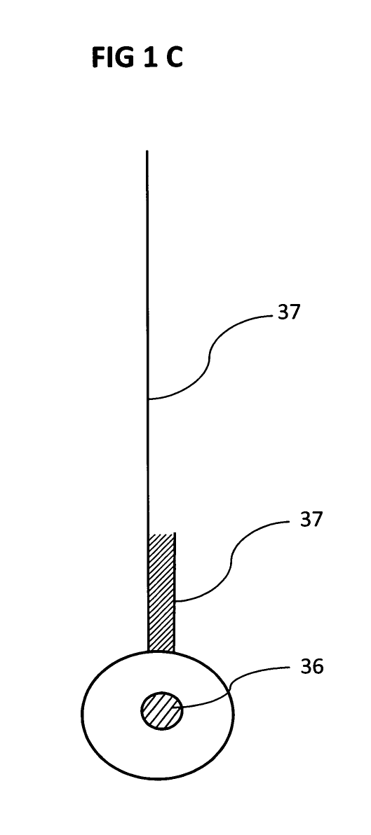

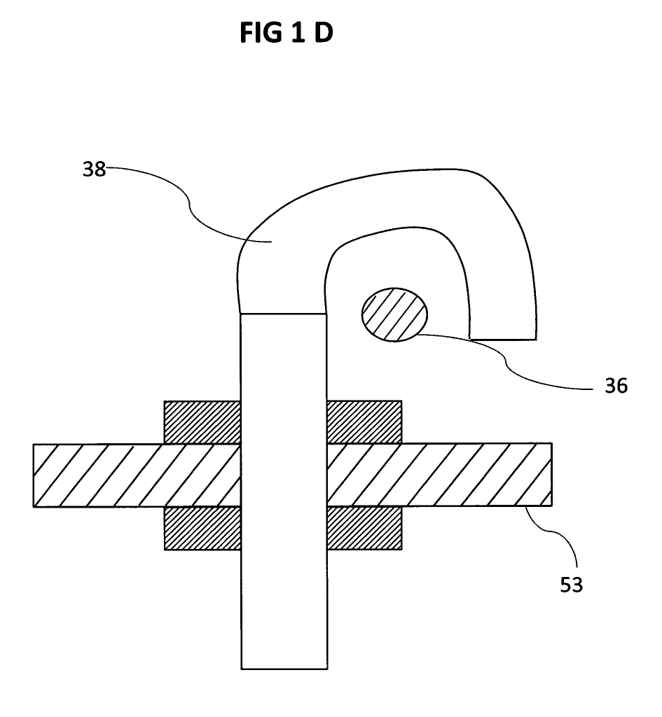

### DETAILED DESCRIPTION FIGS. 1A TO 1D

This is a ten meter long fixed advertising envelope with a soda bottle shape. However the envelope size is according the customer. It is mounted over a fixed or floating circular platform four meter wide 53 dragged by a boat 27. It is made by the union of five equal oval irregular Bopet pieces. In order to have the pieces' shape, the actual plastic bottle is cut in five exact elliptical pieces and then one piece is drawn and magnified.

The pieces are transparent and painted in a black-brown color. The label 33 and the cap 34 are also painted but in red and the logo 35 is written in white. A polyethylene strip five centimeter wide is placed between the two Bopet films. The pieces' brims are melted by heat. An anchoring metallic ring 36 with the same size of the bottle bottom's diameter, two meters, is at the bottle's bottom. The bottle's lower edge folds 37 toward the inside and it is glued on itself creating an edge that surrounds the metallic ring. The platform 53 has some adjustable hooks 38 that fasten the ring. Twenty centimeters above the metallic ring 38 there are two lateral base holes five centimeter wide 29 on the envelope.

At that platform's 53 center there is a laid fan 40 that sends air upwards. Above said fan there is a reflector mounted over three metallic legs. The reflector power will give the lifting power at night. A standard model will have a reflector of eighteen hundred watt twenty amperes 39 connected to an electricity current. At some locations it will be necessary to add an electric generator and/or a battery 54. Strategically, it has a photoreceptor 42 installed and connected to a switch 57 that turns on the reflector and the fan. Additionally and optionally, nearby the reflector there is a post banner four meters long 44 fixed to the platform 53. At the top of the post banner there is a light, a double insulated wire 51 rising along the post banner connected to the electricity generator 41.

The envelope's size is up to the consumer. However the thickness of most of the plastic film is 13 to 16 microns. For large envelopes a thicker film may be used.

### Operation

During the day the brown-dark colored plastic absorbs the heat from the sun rays, making the envelope to become lighter than the air, rising and displaying the advertising. During the night, the photoreceptor turn on the switch and the reflector irradiates heat, the fan cools it sending hot air upward. As the envelopes gets hotter, new air gets into the envelope through the lateral base holes. The reflector emits a narrow beam of light illuminating the bottle from within. The dark color plastic let the light scarcely going through it. Since the label is painted in red and white, it shines contrasting with the dark ocean and the sky.

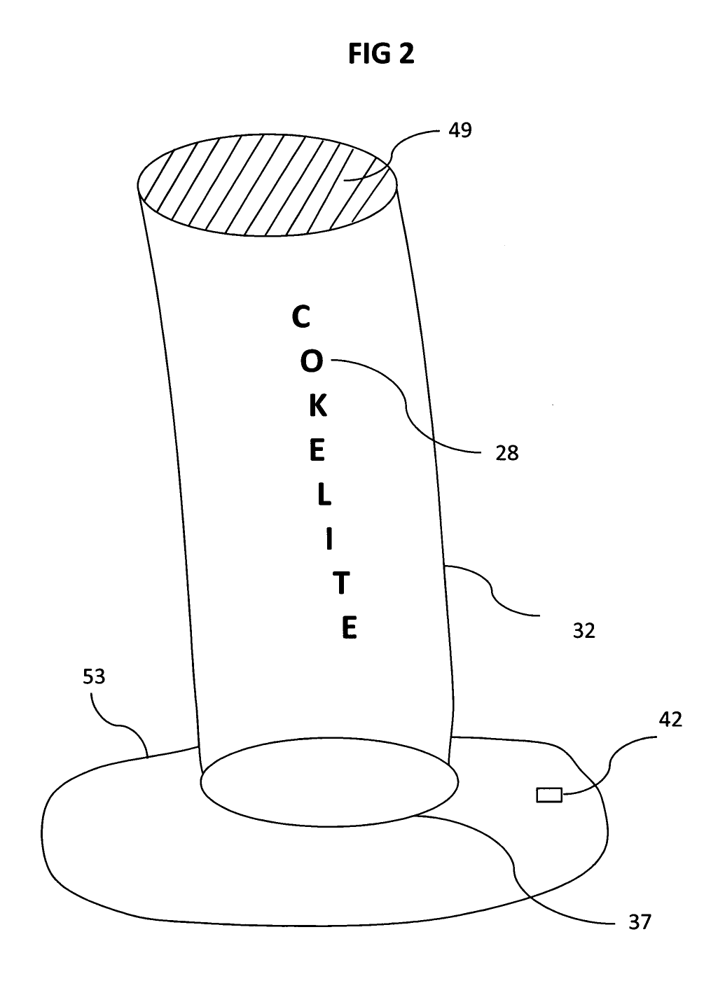

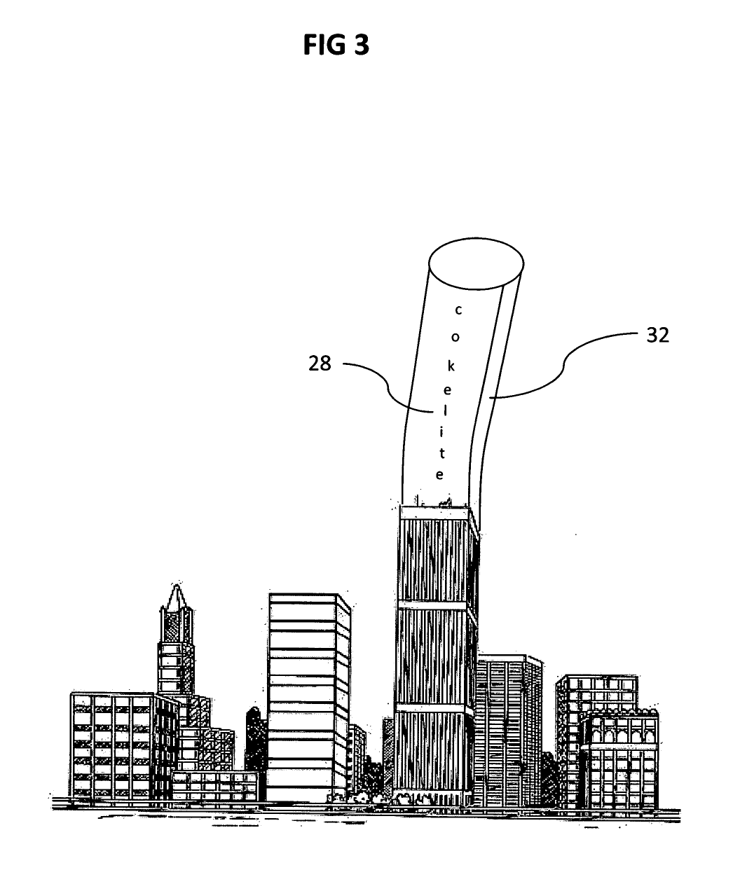

### DETAILED DESCRIPTION FIGS. 2 to 3 ADDITIONAL EMBODIMENTS

The FIG. 2 shows an additional embodiment. The advertising envelope is cylindrical and it rises up in a vertical way. The cylinder's walls are made of transparent plastic painted of some dark color except in the advertising's 28 area. That area is painted in a clear color, over a transparent plastic allowing the light to make the advertising visible.

The cylinder has two ends: an upper and a lower one. The upper end is closed with a rounded plastic film 49 that is glued by heat to the cylinder's walls. This rounded plastic film has two sides, the upper one is black and the lower one has a metallic color.

In the cylinder's lower end there is an anchoring metallic ring 36 with the same size of the cylinder's diameter. The lower end's edge 37 folds toward the inside and it is glued on itself creating an edge that surrounds the metallic ring 36. This metallic ring will be useful to anchor the envelope to the floor, or to a platform 53. At that area's center there is a laid fan 40 and above it, a reflector 39 that sends up light. Strategically, it has a photoreceptor 42 installed and connected to a switch that turns on the reflector 39 and the fan 40.

### Operation

During the day the advertising envelope's dark color film absorbs the solar rays making it lighter than the air and the cylinder's upper end pushes up and rises it, allowing the advertising to be seen by many people. At night or when it is cloudy the photoreceptor 42 recognize that there is insufficient light and turns on the switch for the reflector 41 and the fan 40. The reflector's generated heat will ascend for the cylinder and will be accumulated in the top end. The reflector's light travels by the cylinder's interior crossing the clear parts of the advertising. When it reaches the top end, the light is reflected in the mirrored rounded plastic 49 and it is reflected downward.

The winds will make the envelope to flutter. Because the light is beamed upwards when the envelope flutters, it will produce a non constant light producing an internal light's movement and calling people's attention.

### DETAILED DESCRIPTION FIG. 3

Another additional embodiment is shown in FIG. 3 instead to use a platform the envelope is tight to a building's perimeter. And the additional parts such as fan, reflector are placed on the building roof. The adjustable hooks are fixed to the building. The metallic ring is replaced by a strong pliable wire that adapts to the building shape. The envelope's perimeter must be equal to the building's perimeter, allowing it to be tighten to it.

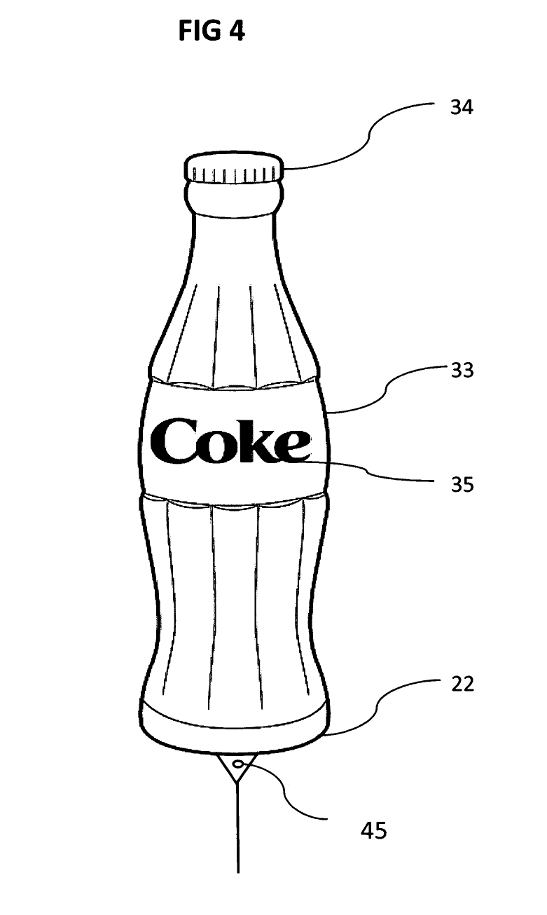

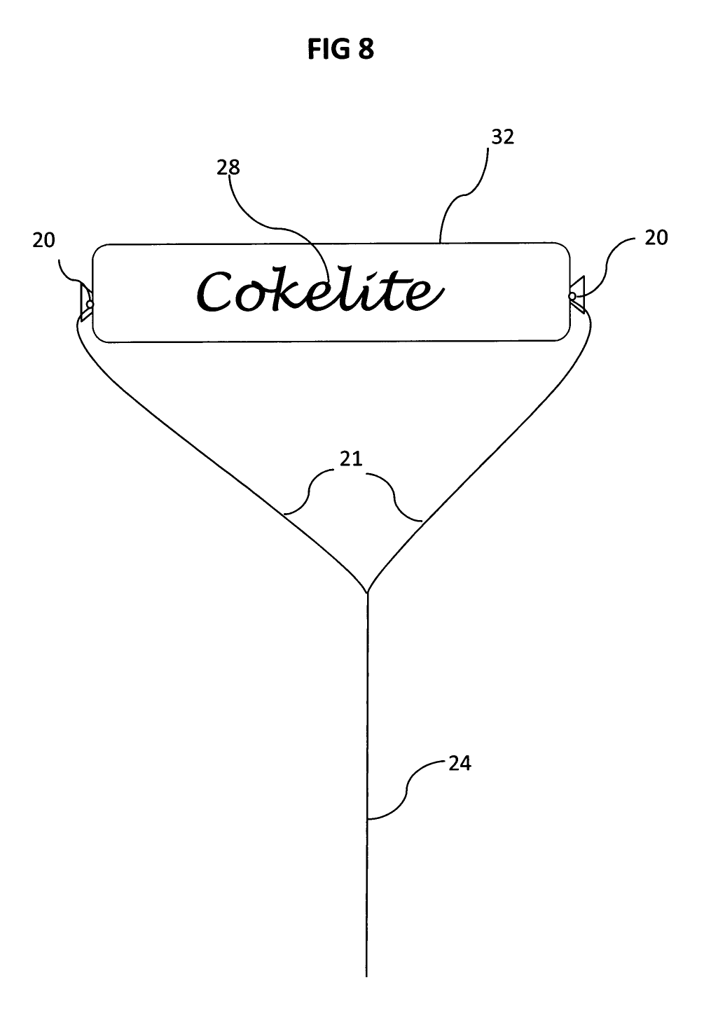

### DETAILED DESCRIPTION FIGS. 4 TO 13 ALTERNATIVE EMBODIMENTS

### DETAILED DESCRIPTION FIG. 4

This envelope is small around two meters long with the shape of a soda bottle. It is made of two light black films of LDPE (low density polyethylene). The plastic is biodegradable. The brims of those films had been melted by heat. The envelope has an underneath hole at the bottom 22. The two faces have the label 33 printed with the same colors that the real bottle. The top is also printed with the cap 34 colors. Around the bottle's bottom, the two sheets continue in a small triangular extension of ten centimeters long 45. These two triangular sheets are melted together leaving a rounded orifice or hole central to the triangle. The control line is a nylon thread, it will be knotted to that hole.

### Operation

Using a hot air compressor or a hair dryer, the envelopes are inflated. Then a control line string 24 is added, the advertising envelope is ready to use. The model is manufactured in bulk and made in the same kind of facilities that plastic bags are made.

Ideal places to distribute them are in crowded areas, such as beaches, concerts, etc. Bigger envelopes can be also made and distributed in the markets where the product is being sold.

Another option is that the envelope can be build using light paper such as paper tissue. The paper's brims are glued together. The ideal is to distribute a material that is biodegradable.

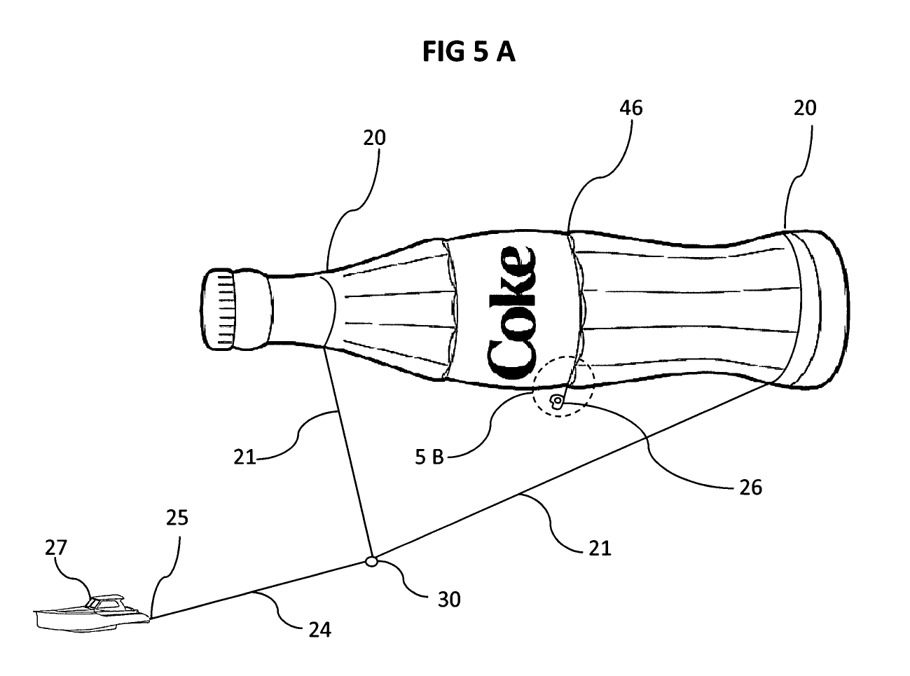

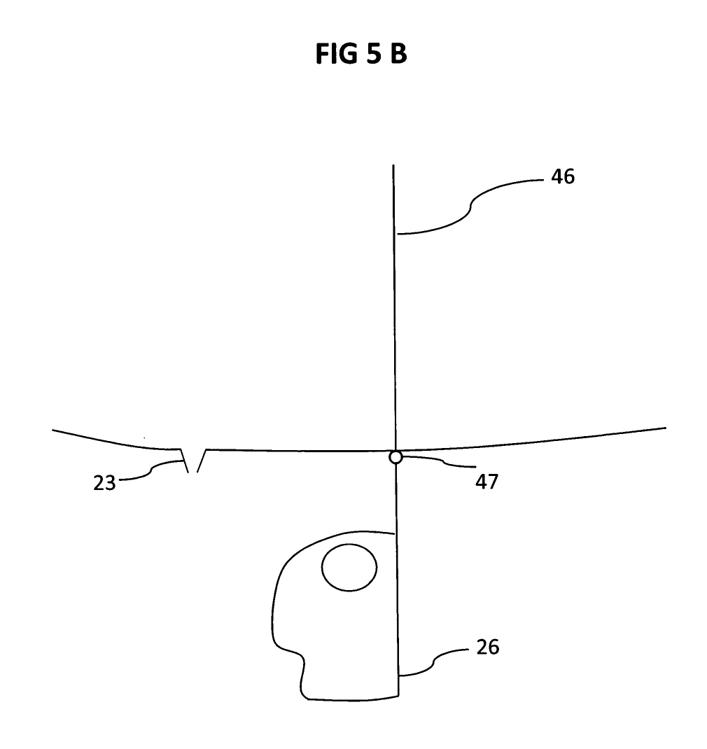

### DETAILED DESCRIPTION FIGS. 5 A & 5 B

This advertising envelope is also made of five irregular oval pieces of Bopet. However, it is a bigger envelope around 100,000 square feet. It has the shape of a giant soda bottle. The brim pieces are melted one to the other by heat, a polyethylene strip is placed between them. The pieces converge or unite, to form the bottle. They are painted with the bottle's colors before being united.

The bottle has two bridles 21, one going to the bottom and the other going to the neck of the bottle. They are attached to the envelope by two surrounding insertion lines 20. They are reinforced by a polypropylene strip. These two bridles 21 converge or unite in a joint bridle ring 30 at which it also joins the control line 24, placing the bottle in a tilt position. The control line attaches to any vehicle 27 such as a jet sky, boat, car, etc.

Another central insertion line 46 surrounds the bottle's half side. This line has a central metallic ring 47 where a harness 26 is going to be hooked. The harness 26 is the same kind as the ones used for paragliders. All the bridles 21 are reinforced by a plastic strip. There is a hole 22 underneath, close to the central ring, located at a passenger's head height. The hole continues with a small light transparent funnel three feet long 23 made of thicker polypropylene. At the funnel's end there is a metallic ring, diameter five centimeter that gives weight, twenty grams, to the funnel's end making it not collapsible.

### Operation

The envelope will be inflated with a hot air compressor. Once the envelope is inflated on the beach, the passenger puts on the harness 26 and hooks the harness hook to the central ring 47. The control line 24 is being released as soon as the advertising envelope 32 rises. Then a jet sky or a beach motorcycle 27 can get started.

This advertising envelope 32 is huge, very visible and also interacts with the people. The ride can have a cost or it can be free.

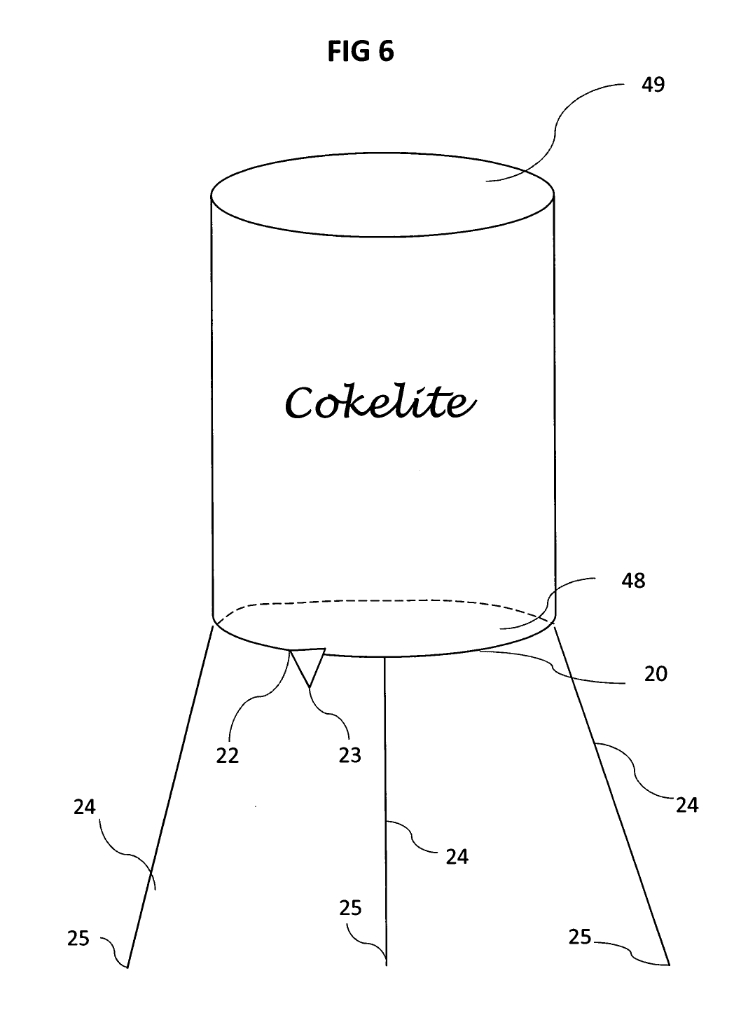

### DETAILED DESCRIPTION FIG. 6

This anchored advertising envelope has the shape of a soda can four meters tall. It is made with a rectangular Bopet sheet, four meters long by six meters wide, which is painted with the (proper) label 33 advertising the soda. The two sheet brims are melted by heat with a polyethylene strip in between forming the can cylinder. At the top and at the bottom, the brims are melted with two circles that close the cylinder. The lower circle 48 is grey resembling an aluminum can. And there is a hole at the center. The upper circle 49 bis is transparent. There is an insertion line 20 that surrounds the can's bottom. From there, three control lines 24 leave the envelope, anchoring it at three anchor points 25, placing the can in a set position.

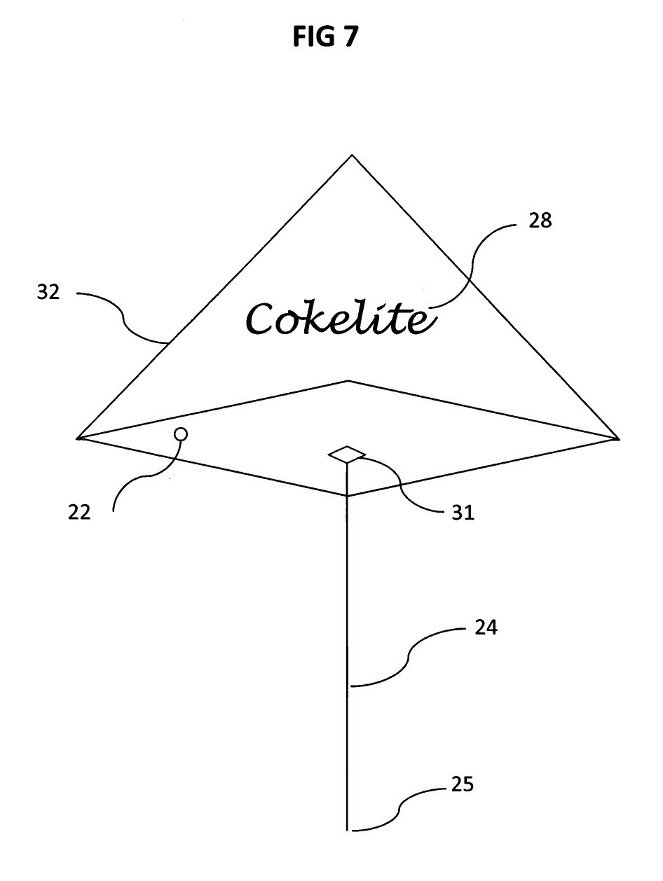

### DETAILED DESCRIPTION FIGS. 7 & 8

These two advertising envelopes are very easy to build. They are made from a rectangular color film, no transparent. They do not have to painted or printed. The advertising 28 is printed on the polyethylene film with the soda logo.

The tetrahedral envelope is a square film of polyethylene two meters long folded in two. Once the sheet is folded, both halves remain one in top of the other. The upper sheet brims are melted together with the lower ones. Only one pair of brims are melted together in a transversal direction giving the envelope volume and its unique shape (tetrahedron). The envelope has a small lower underneath hole two centimeter wide 22 allowing air to go in and out. Near the hole 22, there is a small folded five centimeter high area where the sheets are melted together. At the center of the area there is a small hole so a nylon line can be added to it.

The cylinder is even simpler: it is a polyethylene roll with melted by heat edges. The soda's logo is printed along the cylinder's shape. The cylinder's diameter is provided by the width of the film three meters. The roll is cut at a certain distance providing the cylinder's length, at least two meters long. Two bridles 21 are tied closing the cylinder's edges. The two bridles 21 are tied together and from there the control line 24 continues.

These two models are very simple and cheap to build. They are cheap standard models. They can be useful for different businesses, just changing the printed advertising or logo.

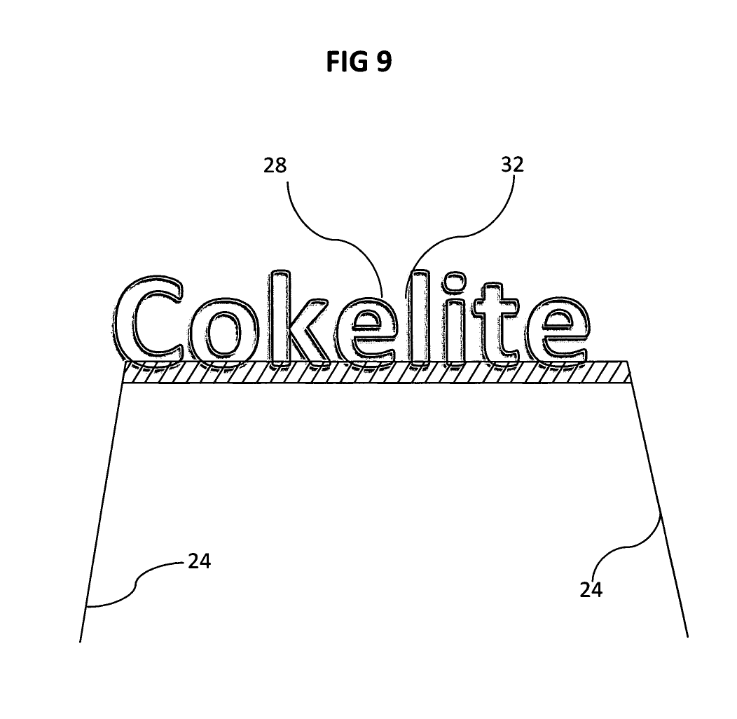

### DETAILED DESCRIPTION FIG. 9

This envelope has the shape of the soda's product name just as it is written in the logo. Cursive letters envelopes are easier to make. The letter size is related to the height or distance that the advertising envelope should rise and they do not need to be printed. Preferably the cross section of every letter has to be superior of sixty centimeter. The two plastic sheets are cut with the shape of the word to be formed and the brims are melted together. At both sides of the word there is one control line. Each one anchors at one anchor point. And it places the advertising envelope 32 in the desired position.

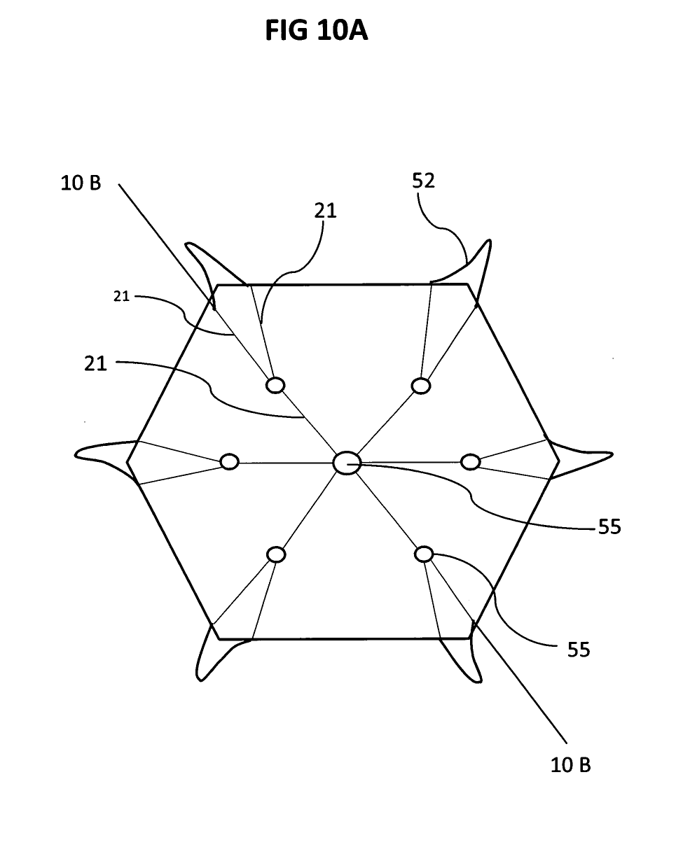

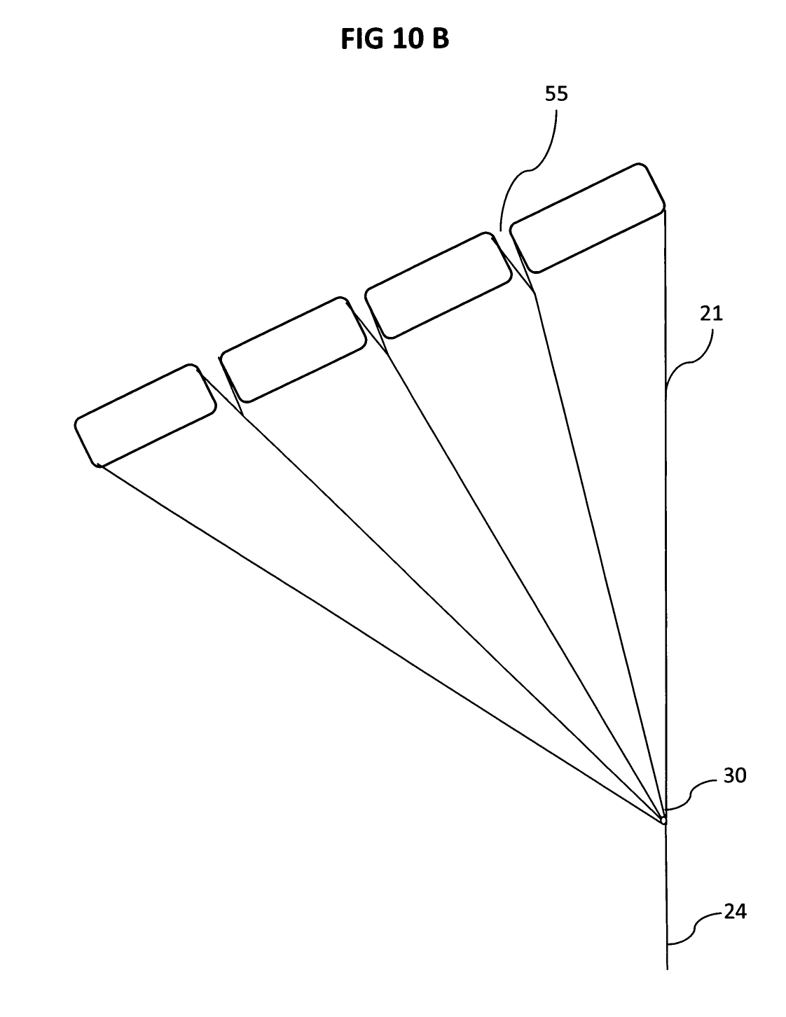

### DETAILED DESCRIPTION FIGS. 10A & 10B

It shows a flat hexagon envelope. Its sides are four meters long. The envelope is made of two Bopet sheets, one upper and one lower. The sheet's edges are melted by heat together using polyethylene strips in between. The space between these two sheets is going to be filled with air.

Seven equidistant circular pieces of polyethylene are melted between the upper and lower face. One of said seven circular pieces is central the others are peripheral. At the core of each melted circle, there is a wind interaction hole 55. It is a hole that interacts with the passing wind. One is central the others peripheral. At the sides of each vertex of the hexahedron there is a fin 52 formed by the two sheets filled with air. These fins 52 are made gluing the sheets in an oblique position regarding the remaining shape of the envelope 32. The lower face shows the soda's logo 35 to advertise and the upper face is either black or transparent.

The bridle lines 21 are fixed to the envelope knotting them in the wind peripheral interaction holes 55, the central interaction hole 55, and each fin 52 side. There are eighteen bridles 21, twelve peripheral and six central. From the join bridle ring 30 three bridles 21 go to each peripheral wind interaction hole 55. From there two bridles 21 go to each fin 52 side and go back to the join bridle ring 30 and the other goes to the central wind 55 interaction hole and goes back to the join bridle ring 30. The bridles' length is different but they place the advertising envelope in a straight position facing the wind at a 20 degree inclination. The control line is also attached to said ring 30.

### Operation

The envelope can be inflated with hot air and sealed so it does not explode later with the sun heat. It is also sealed to provide firmness. The bridles 21 make the flat envelope to receive the winds at a twenty degrees inclination, as if it were a kite. The sun makes the envelope to rise and the winds also help it to rise. The wind interaction holes 55 provide greater lifting power. Big advertising envelopes can be created and be placed up in the sky to be seen by many people. When the wind reaches the fins 52, the envelope revolves making the logo more visible from different angles.

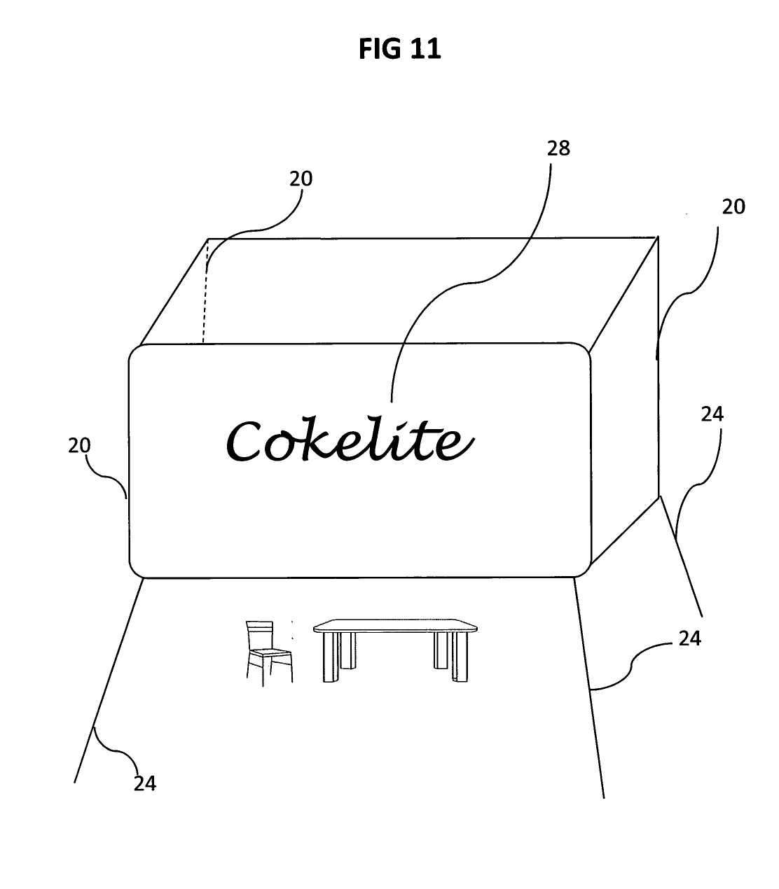

### DETAILED DESCRIPTION FIG. 11

Shows a flat square advertising envelope 32 and in each of the corners there is a control line 24. Each control line 24 anchors in an anchor point 25. Each control line 24 measures two meter high. The lateral sides and the inferior lower face advertise the soda. The superior upper face is black or transparent. When the envelope gets hot, it rises, so at its shadow people can cover from sun exposure. This advertising envelope 32 is especially useful in beach areas.

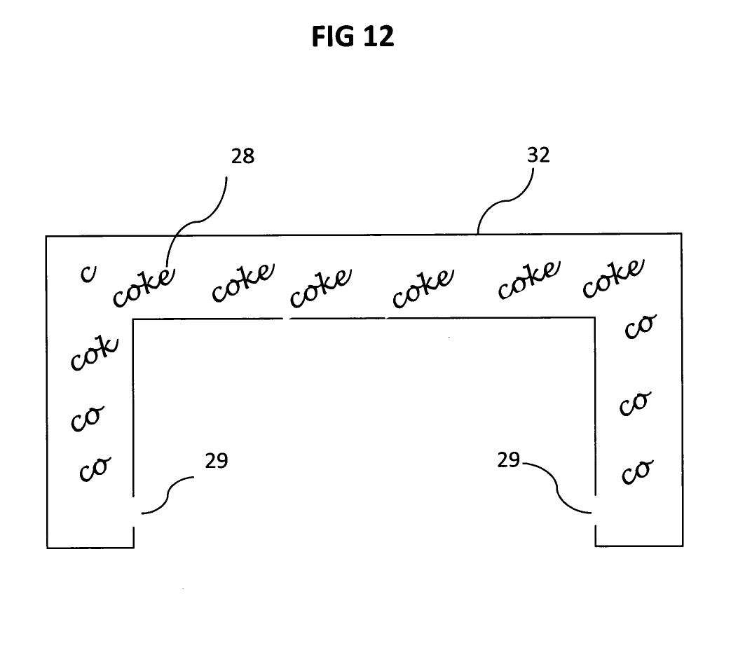

### DETAILED DESCRIPTION FIG. 12

This is a advertising envelope 32 with the shape of a soccer goal. The shape is formed with two posts and a crosspiece, although inwardly there are not separations between them. At the goal's bottom there are some small lateral base holes 29 letting the air in. The posts bases are buried in the sand. When the envelope gets hot, it rises up, giving it shape. The goal advertises the product.

### Advantages

Several advantages of one or more aspects are as follows:
The material is a very thin and cheap plastic or paper sheet.
They are filled with air.
They do not need a crew to fly them.
They can be manufactured.
Small holes in the membrane do not affect the envelope.
They can be used in large quantities to advertise a product.
A cheap and huge sign can rise up in the sky and be seeing by many people.
Small advertising envelopes can be given away to people at strategic places like a beach, a concert to call people's attention.
They have an internal light therefore can be used at night.
They are an eye catchy novelty.
The envelopes' cheap costs allow to give away small advertising envelopes in large quantities to people in popular places like beaches or concerts. They will advertise the product for free and they will appreciate the gift. They can also be distributed to the retailers that sell the products.
As time passes by the envelope does not deflate because it is not pressurized. The more heated they become the more air enters inside the envelope.

### Conclusion, Ramification, and Scope

Buoyant fixed envelopes advertising device heated by the sun/or electrical power allow to advertise in a cheap and new way. The advertising envelope is comprised by a light envelope that encloses a gas, a displayed message that is also given by the form, design, signs and/or color of the envelope.

When the envelope and its gas get warmer, they become lighter than the air and rise. A big black simple envelope can rise high in the sky and lift another envelope with the proper design and advertising.

The energy sources can be the sun or any source of electricity power. The gas or air is heated outwardly by the solar rays. At night it can be heated inwardly by electricity with a resistance such as a lamp. At the areas where the nights are colder, the differences between the temperature inside and outside the envelope are bigger. Therefore the envelopes have more rising power. The light intensity needed to rise the envelope will vary according to the weather, the envelope size, weight and shape.

The energy source that heats the advertising envelope and its gas is not raised with the envelope.

A fixed reflector can also be used and the envelope's bottom end surrounds the reflector receiving light and ascending hot air from underneath.

These envelopes are fixed to the ground. They can float in the air but they are fixed to the ground by control lines. Or the lower end of the envelope's walls can be fixed to the ground and the remaining of the envelope float free.

When the product to be advertised is specified, everything is taken into consideration upon defining the sign characteristics.

Shape: Ideally, the model should have the same figure and shape that the product to be advertised. It could just be a simple envelope with the message printed on it. It is important to consider how the “model” is going to be affected by the winds, by the sun exposure, etc. It is important to consider where and how to attach the bridles to the envelope. Whenever possible, the envelope will be anchored as a kite, meaning that the envelope's biggest or largest face is placed at 20 degrees with regards to the winds. This is in order to increase the lifting power and not to decrease it.

Color and design: Another aspect to contemplate during the designing stage is that the areas directly exposed to the sun should be dark colored or transparent, and the parts not exposed to the sun should be mirrored, in order to avoid losing heat. Although black is the color that best absorbs the sun rays, the envelopes can be constructed in any color. However the worst colors are white and silver. The plastic film can be painted or printed.

If the envelopes have an internal light to be used at night, it is very important that said light can go through the envelope parts to be highlighted. The envelopes can be made with a transparent plastic and be all painted in a dark color except the areas to be highlighted. However they can be made of a clear plastic and instead of being printed or painted all the envelope they can be printed or painted just the parts to be highlighted. This variety of envelopes will reduce the production costs.

Material: Considering materials to build advertising envelopes, they have to be light and preferably hard to break. Bopet has excellent properties but it is hard to melt or glue. A film made of two layers, one Bopet and other Polyethylene will be ideal.

Low density polyethylene (LDPE) is a cheap and great material. Cellophane paper or tissue paper, as any another type of light paper, are very good too and they have the advantage of being biodegradable. It can also be printed in light paper and then be laminated by heat with a light transparent plastic film.

Film Wide: Whatever the material, it is always better to work with wide films. The films should be cut according to the final model and the pieces should be glued together by heat or glue. The two Bopet sheets can be glued using polyethylene strips.

Ecofriendly: Paper o Biodegradable polyethylene are the best choices when the advertising envelopes are given to the general public. Otherwise people will have a negative reaction against the new method of advertising. The patent's owner is responsible for taking care of which advertising envelope will be used, at what time and in which place, otherwise the skies would be filled with advertising envelopes creating visual pollution and also resentment toward this type of advertising.

Industrial process: The two sheet edges are placed together and protected externally with a teflon tape while the heat is applied. This process can be done using an iron or at industrialized level for small advertising envelopes using machines. It is the same technology used at the trash bags industry.

Puffiness: It is convenient but not indispensable for the model to have a hole underneath continued with a non-collapsible light funnel. The funnel will have a metallic ring at the end. It helps the funnel not to collapse and it also gives it some weight. Regardless the wind direction or the envelope's movements, the funnel will not let the hot air escape because the funnel ring weight will always place the funnel exit downward, and the hot air will remain up as it is lighter. The funnel has two purposes: 1. To let the envelope fill completely by itself. When the air gets hot the air ascends sucking more air inside the envelope. 2. When the pressure inside the envelope gets too high, the funnel acts as a valve releasing air. The funnel's diameter is big enough to release the hot air pressure but small enough to expel the sudden extra pressure caused by the winds preventing the model's shape to be altered. It can also be inflated with hot air, making the envelope to rise immediately. The envelope can have a hole and a cap that seals it. Therefore, the air's temperature should be equal to the maximum temperature that the envelope will reach during the day. Once the envelope is filled, it will be sealed with the cap. By doing so, we do not run the risk that later on the envelope bursts for excessive internal pressure. It also rises faster without accidents and achieves a puffy aspect since the beginning of the day.

Insertion line: As each model is unique, the way that the bridles are attached to the envelope are also unique. Instead of having an insertion point, as a general rule, it is convenient that the bridle attaches and sticks to the envelope through an insertion line.

Controlling lines: Most of the time one control line anchored to the anchor point will be enough. Extra control lines and extra anchor points can be added and they will help to place the envelope in a particular position. Nylon lines are strong, cheap and light.

Visible at night: This advertising device would have a resistance connected to an electric current. The resistance can be a lamp. It is convenient to work with transparent plastics and paint them with dark colors and some areas as logos can be painted in light colors so at night the sign is still visible. Fluorescent painting will have a greater impact on calling people's attention.

The envelope can also be made in clear colors. Later on they can be printed and be raised by a heat resistance.

Dragged by vehicles: The anchor point can be fixed or attached to a vehicle. The envelope can be dragged by a jet ski, a car, a boat, a paraglider, etc.

Convey a message: These are advertising envelopes conveying a message. Just as an example, without limiting its scope, a message can be a character, a number, a word, a sentence, a picture, an idea, an add, a logo, a product, a brand, a flag, a sign, a team jersey t-shirt. The message can also advertise, show support, show belonging, show opposition, express idea, support to people, to candidates, to teams, places, countries, etc.

All the embodiments described above were designed to advertise one product. But there are hundreds of ideal products to promote using advertising envelopes and for each one of them there is a unique design to advertise that product. However, all of them have in common that they communicate a message.

Certain “things” are mostly dark colored, and ideal to create advertising envelopes, using their own shape and color and adding only the logo brand name in a different color.

The following products are not different embodiments, just products examples:
1. Dark color sodas.
2. Wine bottles.
3. Beer bottles such as Budweiser Select.
4. Dark color cans such as Coke Max or Monster.
5. Advertising envelopes with a box shape such as whisky “Black Level”.
6. Advertising envelopes with car or truck shapes.
7. Advertising envelopes with clothing, suits, shoes such as Nike.
8. Advertising envelopes with tire shapes.
9. Advertising envelopes with musical instruments shapes such as guitars, etc. to advertise concerts.
10. Electronic gadgets: cell phones such as Iphone, computers, tvs, cameras, razors, etc.
11. Dark penis advertising erotic gadgets.
12. Characters such as Mickey, Pluto, Felix, etc.
13. Chocolates such as Hersheys, M&M, etc.
14. Advertising envelopes with boxing gloves shape.
15. Condoms such as Black Prime.
16. Advertising envelopes with brand logos shapes such as Nike, Adidas, Gillete, ABCnews, Macys, Office Max, Scotch, Advil, Braun, Boost Mobile, BMW, etc.
17. Advertising envelopes s with personal care products such as Axe deodorant, Tresemme.
18. Advertising envelopes with the colors and symbols of different sport teams.
19. Advertising envelopes with the shape of a jersey t-shirt with and a long control line and the colors and symbols of different sport teams. So that every fan can go to the stadium and fly his or her own advertising envelope without interfering with the game view. Or also display show it at home. Teams that are ideal to use advertising envelopes are NFL Raiders, NBA Miami Heat (black jersey) Sixers, Bulls, Spurs, Pittsburg Steelers, Mets, All Blacks rugby, etc.
20. Advertising envelopes with battery shapes such as Duracell.
21. Signs such as a religious Cross or Star of David.
22. Advertising envelopes with the shape and the printed picture of a person, such as a celebrity, in order to advertise him/her.
23. Advertising envelopes with a control line and the colors and design of the flag of the different countries. So that every person can use it showing his or her patriotism.
24. Advertising envelopes with a control line and the design that shows support to a candidate, to an idea, etc. So that every person can use it and show his/her affiliation or support.
25. Advertising envelopes with animal shapes such as whales, orcas, elephants, penguins, panthers, bold eagles, promoting places, mascots, etc

Some advertising envelopes will not advertise a product but they will convey a message. In this case the envelope's cutting and printing will be manufactured and then, they will be sold to the general public.

A list of those messages could be:
26. Dark Advertising envelopes with printed words in clear colors or shades such as, Happy Birthday, Merry Christmas, Happy Hanukkah, Congratulations, etc.
27. Advertising envelopes such as Open House, For Sale, For Rent, Yard Sale, etc.
28. Outdoor fair advertising envelopes such as bathrooms, exit, parking, first aid, food court, etc.
29. Traffic advertising envelopes. For instance, a policeman suddenly needs to indicate immediately something such as a closed road to avoid cars getting into a highway, he unfolds the advertising envelope with the correct inscription, connects it to the muffler of an ignited car and in minutes the sign is visible from afar.
30. Warning advertising envelopes such as “wear your seatbelt”, “wear your helmet”, “do not smoke”, etc.

The following are envelopes with particular useful shapes that can be used to advertise products:
31. A flattened envelope with two films, upper and lower. Each film has two faces. The upper film can be black or transparent. The lower film has also two faces; the lower is where the advertisement or the message will be printed. When the upper film is transparent, the upper face of the lower film is black. When the upper film is black, the upper face of the lower film is mirrored. The two laminates melt together at a set distance in a rounded shape. Those rounded shapes have a central hole where the bridles are tied so the advertising envelope's lines tilt it with a 10-20 degrees inclination.
32. Envelopes with any pyramidal or cylindrical shape, etc. that are tied to the ground with lines. The sun's lifting power raises the advertising envelope promoting the “thing” or product and creating underneath a shadow where people can have lunch outdoors. The inferior face and the one not exposed to the sun are made of a mirrored membrane and the face confronting the sun is made of black plastic.
33. A small envelope that it is tied to a fishing line. The fishing line has a float and a light sinker. The advertising envelope can only be used when the winds directions are opposite to the shore. The advertising envelope raises and has the power to carry the line further and further, but it does not have the power to lift the float, so the hook is always under the water and moving.
34. Advertising envelopes with the shape of a soccer goal, volley net in order to be placed on a beach to advertise the product.
35. All the products can be advertised with envelopes big enough to transport a person. The person in charge of taking care of the advertising envelope can rent it for a few minutes to travel short trips, always anchoring the advertising envelope to the anchor point. This way the advertising company should not have any hiring cost by paying to the person taking care of the advertising envelope.

Concluding advertising envelopes is also a method for advertising products using said advertising envelopes and it is also a business method consisting in designing, manufacturing and displaying in public said advertising envelopes.

Thus the reader will see that at least one advertising envelope embodiment allows to convey a message in a cheap, striking and new way. Although the above description contains many specifications these should not be construed as limitations on the scope of any embodiment, but as exemplifications of various embodiments thereof. Many other ramifications and variations are possible within the teachings of the various embodiments. Thus the scope should be determined by the appended claims and their legal equivalents, and not by the examples given.

I claim:

1. An anchored envelope having a message, holding a gas wherein said envelope and said gas are together heavier than the air and when said gas is heated either by the sun or an electricity source said envelope and gas becomes lighter than the air, rising and displaying or lifting an object that displays said message, whether the message is a logo, an icon, a symbol, a sign, a number, a letter, a word, a product, a picture, or a combination of said options, as a means to convey any message.

2. The anchored envelope of claim 1 wherein said envelope is similar in shape to the advertised item.

3. The fixed envelope of claim 1 wherein said anchored envelope is similar in design to the advertised item.

4. The anchored envelope of claim 1 wherein the energy source is the sun.

5. The anchored envelope of claim 1 wherein the energy source is an electricity generator or a battery.

6. The anchored envelope of claim 1 wherein said anchored envelope has the sun and an electricity generator as energy sources, whereby said energy sources can be used simultaneous or separately as needed.

7. The anchored envelope of claim 1 wherein said anchored envelope lifts or holds in position another object heavier than the air whereby the object is placed in a convenient and predetermined place and the anchored envelope is placed higher and far away.

8. The anchored envelope of claim 1 wherein the anchored envelope is filled with gas already heated.

9. The anchored envelope of claim 1 wherein the bridles of said anchored envelope are attached in a predetermined way whereby the anchored envelope has a means to receive the wind energy as a lifting power.

10. An advertising device, comprising:
a. an advertising
b. a fixed envelope holding a gas
c. said gas
d. the sun and/or an electricity generator or battery as energy source wherein said envelope and gas are heavier than the air and when said energy source heats the gas and envelope, they become lighter than the air, rising and advertising the product.

11. The advertising device of claim 10 wherein the energy source is an electricity generator device, it has a conductive element and a resistance as a means to heat the gas.

12. The advertising device of claim 10, further including one or a plurality of several accessories selected from the group consisting of photoreceptor, fan, fins, portable electricity generator, platform, metallic ring, banner post, reflector, vehicle, bridle, control line, funnel, harness, mirrored plastic films, not insulated wire, insulated wire.

13. The advertising device of claim 10 wherein the resistance is a fixed lamp, the envelope has an elongated shape and the inferior end is open and anchored to the ground, surrounding said lamp, whereby the anchored envelope receives light from underneath making it visible at night, and the hot air caused by the lamp elevates inside said anchored envelope making the top of the envelope lighter than the air and keeps the anchored envelope standing and straight.

14. The advertising device of claim 10 wherein the envelopes have simple shapes, are made with a non transparent plastic film and the advertising is printed on the said envelopes, whereby said envelopes can be manufactured to reduce production costs.

15. A method for advertising comprising:
a. an anchored envelope holding a gas,
b. an advertising displayed by said anchored envelope,
c. said gas.
d. an energy source either the sun or an electricity generator, wherein the said envelope and said gas are together heavier than the air, wherein said energy source heats the gas and the anchored envelope becomes lighter than the air and lifts the anchored envelope or the upper part of the anchored envelope, whereby the anchored envelope displays or lifts an object that displays a logo, an icon, a symbol, a sign, a number, a letter, a word or a combination of said options, advertising an item.

16. The method of claim 15 further including designing, manufacturing or displaying in public said advertising envelope, whereby a profitable business can be created.
